(19) United States
(12) Patent Application Publication
(10) Pub. No.: US 2022/0245672 A1
(43) Pub. Date: Aug. 4, 2022

(54) Method, Apparatus, and Computer Program Product for Generating Graphical User Interface for Facilating Complex User Interactions

(71) Applicant: Groupon, Inc., Chicago, IL (US)

(72) Inventors: Alan Spadoni, Chicago, IL (US); Vladimir Hadzhiyski, Chicago, IL (US); Truman Anton Shuck, Chicago, IL (US); Kyle Thomas Jennings, Chicago, IL (US)

(21) Appl. No.: 17/657,058

(22) Filed: Mar. 29, 2022

Related U.S. Application Data
(63) Continuation of application No. 14/670,558, filed on Mar. 27, 2015, now abandoned.
(60) Provisional application No. 61/971,735, filed on Mar. 28, 2014.

(51) Int. Cl. G06Q 30/02

(52) U.S. Cl. CPC G06Q 30/0255

(57) ABSTRACT

Methods, apparatuses, and computer program products are provided herein to facilitate using consumer data from external sources in determining relevance measures for promotions and to facilitate the generation of impressions comprising one or more promotions for a consumer from a promotion and marketing service. In one embodiment, a method for generating promotion impressions is provided which includes receiving consumer data from a content provider system; determining one or more available promotions based in part on the consumer data; and generating an impression comprising the one or more available promotions. A corresponding apparatus and computer program product are also provided.

### CROSS REFERENCES TO RELATED APPLICATIONS

The present application is a continuation of U.S. Non-Provisional application Ser. No. 14/670,558, filed Mar. 27, 2015, which claims the benefit of Provisional Application No. 61/971,735, filed Mar. 28, 2014, the contents of which are hereby incorporated by reference in its entirety.

### FIELD

Embodiments of the invention relate, generally, to determining relevance signals for promotions to facilitate generating impressions for a consumer within an application.

### BACKGROUND

Promotion and marketing services seek to encourage consumers to explore and discover available promotions that the consumer may be interested in, and as a result provide methods for using a variety of relevance measures to determine what available promotions should be presented to a consumer. In this regard, a number of deficiencies and problems associated with the methods and systems used to, among other things, identify promotions which may have a particular relevance to a consumer have been identified. Through applied effort, ingenuity, and innovation, many of these identified problems have been solved by developing solutions that are included in embodiments of the present invention, some examples of which are described herein.

### BRIEF SUMMARY

Accordingly, a method, apparatus, and computer program product are provided to facilitate using consumer data from content providers in determining relevance measures for promotions and to facilitate the generation of impressions comprising one or more promotions for a consumer from a promotion and marketing service.

A method is provided for generating promotion impressions, the method at least including receiving consumer data from a content provider system, wherein the consumer data comprises one or more indications of consumer preferences for interacting with the content provider system and determining one or more available promotions based in part on the consumer data, the one or more available promotions having redemption parameters that satisfy one or more of indications in the consumer data. The method further including generating an impression within the content provider system comprising the one or more available promotions.

In some embodiments, the method may further include determining a location for the consumer and filtering the one or more available promotions based on the consumer location.

In some embodiments, the method may further include wherein the one or more available promotions comprise performance event promotions.

In some embodiments, the method may further include wherein the consumer data comprises artist information stored in a library associated with the consumer in the content provider system. In some embodiments, the method may further include wherein the one or more available promotions are presented in an order based on a play frequency for an artist or a frequency of appearance of an artist in the consumer data.

In some embodiments, the method may further include wherein the consumer data comprises artist information stored in a playlist associated with the consumer in the content provider system. In some embodiments, the method may further include wherein the consumer data comprises artist information for a file currently being played by the consumer in the content provider system.

In some embodiments, the method may further include wherein the consumer data comprises genre information stored in a library associated with the consumer in the content provider system. In some embodiments, the method may further include wherein the consumer data comprises movie information stored in a library associated with the consumer in the content provider system.

In some embodiments, the method may further include wherein the consumer data comprises interactions of the consumer with members of a social network in the content provider system. In some embodiments, the method may further include wherein the consumer's interactions comprise one or more of artists being played by one or more members of the consumer's social network; artists recommended to the consumer by one or more members of the consumer's social network; or promotions purchased by one or more members of the consumer's social network.

A method is provided for generating promotion impressions, the method at least including receiving consumer data from a content provider system; determining one or more available event promotions based in part on the consumer data; and determining one or more travel promotions associated with the location of the one or more available event promotions. The method further includes generating an impression within the content provider system comprising the one or more available event promotions and the one or more travel promotions.

An apparatus is provided comprising at least one processor and at least one memory including computer-executable program instructions, the computer-executable program instructions configured to, with the at least one processor, cause the apparatus to at least receive consumer data from a content provider system, wherein the consumer data comprises one or more indications of consumer preferences for interacting with the content provider system and determine one or more available promotions based in part on the consumer data, the one or more available promotions having redemption parameters that satisfy one or more of indications in the consumer data. The apparatus further comprising computer-executable program instructions configured to, with the at least one processor, cause the apparatus to generate an impression within the content provider system comprising the one or more available promotions.

In some embodiments, the apparatus may further comprise computer-executable program instructions configured to, with the at least one processor, cause the apparatus to determine a location for the consumer and filter the one or more available promotions based on the consumer location.

In some embodiments, the apparatus may further comprise wherein the one or more available promotions comprise performance event promotions.

In some embodiments, the apparatus may further comprise wherein the consumer data comprises artist information stored in a library associated with the consumer in the content provider system. In some embodiments, the apparatus may further comprise wherein the one or more available promotions are presented in an order based on a play frequency for an artist or a frequency of appearance of an artist in the consumer data.

In some embodiments, the apparatus may further comprise wherein the consumer data comprises artist information stored in a playlist associated with the consumer in the content provider system. In some embodiments, the apparatus may further comprise wherein the consumer data comprises artist information for a file currently being played by the consumer in the content provider system.

In some embodiments, the apparatus may further comprise wherein the consumer data comprises genre information stored in a library associated with the consumer in the content provider system. In some embodiments, the apparatus may further comprise wherein the consumer data comprises movie information stored in a library associated with the consumer in the content provider system.

In some embodiments, the apparatus may further comprise wherein the consumer data comprises interactions of the consumer with members of a social network in the content provider system. In some embodiments, the apparatus may further comprise wherein the consumer's interactions comprise one or more of: artists being played by one or more members of the consumer's social network; artists recommended to the consumer by one or more members of the consumer's social network; or promotions purchased by one or more members of the consumer's social network.

An apparatus is provided comprising at least one processor and at least one memory including computer-executable program instructions, the computer-executable program instructions configured to, with the at least one processor, cause the apparatus to at least receive consumer data from a content provider system; determine one or more available event promotions based in part on the consumer data; and determine one or more travel promotions associated with the location of the one or more available event promotions. The apparatus further comprising computer-executable program instructions configured to, with the at least one processor, cause the apparatus to generate an impression within the content provider system comprising the one or more available event promotions and the one or more travel promotions.

A computer program product is provided comprising at least one non-transitory computer-readable storage medium having computer-executable program instructions stored therein, the computer-executable program instructions comprising program instructions, when executed by a processor, configured to receive consumer data from a content provider system, wherein the consumer data comprises one or more indications of consumer preferences for interacting with the content provider system and determine one or more available promotions based in part on the consumer data, the one or more available promotions having redemption parameters that satisfy one or more of indications in the consumer data. The computer program product further comprises program instructions, when executed by a processor, configured to generate an impression within the content provider system comprising the one or more available promotions.

In some embodiments, the computer program product may further comprise program instructions, when executed by a processor, configured to determine a location for the consumer and filter the one or more available promotions based on the consumer location.

In some embodiments, the computer program product may further comprise wherein the one or more available promotions comprise performance event promotions.

In some embodiments, the computer program product may further comprise wherein the consumer data comprises artist information stored in a library associated with the consumer in the content provider system. In some embodiments, the computer program product may further comprise wherein the one or more available promotions are presented in an order based on a play frequency for an artist or a frequency of appearance of an artist in the consumer data.

In some embodiments, the computer program product may further comprise wherein the consumer data comprises artist information stored in a playlist associated with the consumer in the content provider system. In some embodiments, the computer program product may further comprise wherein the consumer data comprises artist information for a file currently being played by the consumer in the content provider system.

In some embodiments, the computer program product may further comprise wherein the consumer data comprises genre information stored in a library associated with the consumer in the content provider system. In some embodiments, the computer program product may further comprise wherein the consumer data comprises movie information stored in a library associated with the consumer in the content provider system.

In some embodiments, the computer program product may further comprise wherein the consumer data comprises interactions of the consumer with members of a social network in the content provider system. In some embodiments, the computer program product may further comprise wherein the consumer's interactions comprise one or more of: artists being played by one or more members of the consumer's social network; artists recommended to the consumer by one or more members of the consumer's social network; or promotions purchased by one or more members of the consumer's social network.

A computer program product is provided comprising at least one non-transitory computer-readable storage medium having computer-executable program instructions stored therein, the computer-executable program instructions comprising program instructions, when executed by a processor, configured to receive consumer data from a content provider system; determine one or more available event promotions based in part on the consumer data; and determine one or more travel promotions associated with the location of the one or more available event promotions. The computer program product further comprises program instructions, when executed by a processor, configured to generate an impression within the content provider system comprising the one or more available event promotions and the one or more travel promotions.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates an example system within which embodiments of the present invention may operate;

FIG. 2 illustrates a flowchart describing example operations facilitating the generation of promotions in accordance with some example embodiments discussed herein;

FIG. 3 illustrates a flowchart describing example operations facilitating the generation of promotions in accordance with some example embodiments discussed herein;

FIG. 4 illustrates a flowchart describing example operations facilitating the generation of promotions in accordance with some example embodiments discussed herein;

FIG. 5 illustrates a flowchart describing example operations facilitating the generation of promotions in accordance with some example embodiments discussed herein;

FIG. 6 illustrates a flowchart describing example operations facilitating the generation of promotions in accordance with some example embodiments discussed herein;

FIGS. 7-8 illustrate some example graphical user interface displays that may be presented by various components of systems or devices in accordance with some example embodiments discussed herein; and

FIG. 9 illustrates a block diagram of an example device providing operations in accordance with some example embodiments discussed herein.

### DETAILED DESCRIPTION

### Glossary

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the other computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like.

As used herein, the term “promotion and marketing service” may include a service that is accessible via one or more computing devices and is operable to provide example promotion and/or marketing services on behalf of one or more providers that are offering one or more instruments that are redeemable for goods, services, experiences and/or the like. In some examples, the promotion and marketing service may take the form of a redemption authority, a payment processor, a rewards provider, an entity in a financial network, a promoter, an agent, and/or the like. As such, the service is, in some example embodiments, configured to present one or more promotions via one or more impressions, accept payments for promotions from consumers, issue instruments upon acceptance of an offer, participate in redemption, generate rewards, provide a point of sale device or service, issue payments to providers and/or or otherwise participate in the exchange of goods, services or experiences for currency, value and/or the like.

As used herein, the terms “provider” and “merchant” may include a business owner, consigner, shopkeeper, tradesperson, vendor, merchant, operator, entrepreneur, agent, dealer, organization or the like that is in the business of a providing a good, service or experience to a consumer, facilitating the provision of a good, service or experience to a consumer and/or otherwise operating in the stream of commerce. One example provider may be a running company that sells attire for use by a person who runs or participates in athletic activities.

As used herein, the term “consumer” may include a client, customer, purchaser, shopper, user, or the like, who may be in the position to or does exchange value for one or more instruments under the terms defined by one or promotions. For example, and using the aforementioned running company as the example provider, a consumer may be an individual who is interested in purchasing running shoes.

As used herein, the term “consumer interface” may include any digitally rendered user interface displayed on a visual display device for enabling a consumer to interface with a promotion and marketing service. An exemplary consumer interface may enable a consumer to view one or more promotions, purchase one or more promotions, share one or more promotions with other consumers, receive messages and/or promotions from other consumers, receive messages from the promotion and marketing service, and the like. Exemplary consumer interfaces may be rendered in any desired form including, but not limited to, as a mobile application for display on a mobile computing device (e.g., a smartphone), a webpage or website for display on a mobile or non-mobile computing device via the Internet, and the like.

As used herein, the term “promotion” may include any type of offered, presented or otherwise indicated reward, discount, coupon, credit, deal, incentive, discount, media or the like that is indicative of a promotional value or the like that upon purchase or acceptance results in the issuance of an instrument that may be used toward at least a portion of the purchase of particular goods, services and/or experiences defined by the promotion. An example promotion, using the aforementioned running company as the example provider, is $25 for $50 toward running shoes. In some examples, the promotion defines an accepted value (e.g., a cost to purchase the promotion), a promotional value (e.g., the value of the resultant instrument beyond the accepted value), a residual value (e.g., the value upon return or upon expiry of one or more redemption parameters), one or more redemptions parameters, and/or the like. Using the running company promotion as an example, the accepted value is $25 and the promotional value is $50. In this example, the residual value may be equal to the accepted value.

As used herein, the term “impression” may include a communication, a display, or other perceived indication, such as a flyer, print media, e-mail, text message, application alert, mobile applications, mobile notifications, other type of electronic interface or distribution channel, and/or the like, of one or more promotions. For example, and using the aforementioned running company as the example provider, an e-mail communication sent to consumers that indicates the availability of a promotion of $25 for $50 toward running shoes.

As used herein, the term “instrument” may include any type of gift card, tender, voucher, electronic certificate, medium of exchange, or the like, that embodies the terms of the promotion from which it results and which may be used toward at least a portion of the purchase, acquisition, procurement, consumption, or the like, of goods, services and/or experiences. In some examples, an instrument may take the form of tender that has a given value that is exchangeable for goods, services and/or experiences and/or a reduction in a purchase price of a particular good, service, or experience. In some examples, the instrument may have multiple values, such as an accepted value, a promotional value, and/or a residual value. For example, using the aforementioned running company as the example provider, an instrument may comprise an electronic indication in a mobile application that shows $50 of value to spend at the running company. In some examples, the accepted value of the instrument is defined by the value exchanged for the instrument. In some examples, the promotional value of the instrument is defined by the promotion from which the instrument resulted and is the value of the instrument beyond the accepted value. In some examples, the residual value of the instrument is the value after redemption, the value after the expiry or other violation of a redemption parameter, the return or exchange value of the instrument, or the like.

As used herein, the term “redemption” may include the use, exchange or other presentation of an instrument for at least a portion of a good, service, or experience as defined by the instrument and its related offer. In some examples, redemption includes the verification of validity of the instrument. In other example embodiments, redemption may include an indication that a particular instrument has been redeemed and thus no longer retains an actual, promotional, and/or residual value (e.g., full redemption). In other example embodiments, redemption may include the redemption of at least a portion of an instrument's actual, promotional, and/or residual value (e.g., partial redemption). An example of redemption, using the aforementioned running company as the example provider, is exchanging a $50 instrument and $50 for a $100 pair of running shoes.

As used herein, the term “content provider system” may be separate and distinct from the promotion and marketing service. The term “content provider system” may include a system or service that is accessible via one or more computing devices and is operable to provide one or more types of content to a consumer, facilitate a consumer accessing, tracking, viewing and/or listening to one or more types of content, facilitate one or more types of interactions for a consumer, and/or the like. In some examples, the content provider system may be embodied as system facilitating access to television, video, and/or music services whereby a consumer may view and/or listen to television, video, and/or music content, develop libraries of television, video, and/or music content, share television, video, and/or music content with other consumers, make recommendations of television, video, and/or music content, and the like. In some examples, the content provider system may be embodied as a system providing a social network platform whereby a consumer may follow or interact with one or more other members of a social network. In some examples, the content provider system may be embodied as a system providing a platform for a consumer to discover, track, collect, tag, and/or share interests in topics, projects, content, activities, and the like. In other examples, the content provider system may be embodied as a system providing a platform for travel activities such as discovering travel opportunities, making travel arrangements, purchasing travel related fares, activities, experiences, lodging, etc., sharing travel activities and/or information, providing travel recommendation and/or reviews, and the like. In some examples, the content provider system may be embodied as a system providing a marketplace for discovering, purchasing, providing recommendations and/or reviews, and the like for a variety of goods and services.

As used herein, the term “electronic marketing information” refers to various electronic data and signals that may be interpreted by a promotion and marketing service to provide improved electronic marketing communications. Electronic marketing information may include, without limitation, clickstream data (defined below), transaction data (defined below), location data (defined below), communication channel data (defined below), discretionary data (defined below), or any other data stored by or received by the promotion and marketing service for use in providing electronic communications to consumers.

As used herein, the term “clickstream data” refers to electronic information indicating content viewed, accessed, edited, or retrieved by consumers. This information may be electronically processed and analyzed by a promotion and marketing service to improve the quality of electronic marketing and commerce transactions offered by, through, and in conjunction with the promotion and marketing service. It should be understood that the term “clickstream” is not intended to be limited to mouse clicks. For example, the clickstream data may include various other consumer interactions, including without limitation, mouse-over events and durations, the amount of time spent by the consumer viewing particular content, the rate at which impressions of particular content result in sales associated with that content, demographic information associated with each particular consumer, data indicating other content accessed by the consumer (e.g., browser cookie data), the time or date on which content was accessed, the frequency of impressions for particular content, associations between particular consumers or consumer demographics and particular impressions, and/or the like.

As used herein, the term “transaction data” refers to electronic information indicating that a transaction is occurring or has occurred via either a merchant or the promotion and marketing service. Transaction data may also include information relating to the transaction. For example, transaction data may include consumer payment or billing information, consumer shipping information, items purchased by the consumer, a merchant rewards account number associated with the consumer, the type of shipping selected by the consumer for fulfillment of the transaction, or the like.

As used herein, the term “location data” refers to electronic information indicating a particular location. Location data may be associated with a consumer, a merchant, or any other entity capable of interaction with the promotion and marketing service. For example, in some embodiments location data is provided by a location services module of a consumer mobile device. In some embodiments, location data may be provided by a merchant indicating the location of consumers within their retail location. In some embodiments, location data may be provided by merchants to indicate the current location of the merchant (e.g., a food truck or delivery service). It should be appreciated that location data may be provided by various systems capable of determining location information, including, but not limited to, global positioning service receivers, indoor navigation systems, cellular tower triangulation techniques, video surveillance systems, or radio frequency identification (RFID) location systems.

As used herein, the term “communication channel data” refers to electronic information relating to the particular device or communication channel upon which a merchant or consumer communicates with the promotion and marketing service. In this regard, communication channel data may include the type of device used by the consumer or merchant (e.g., smart phone, desktop computer, laptop, netbook, tablet computer), the Internet Protocol (IP) address of the device, the available bandwidth of a connection, login credentials used to access the channel (e.g., a user account and/or password for accessing the promotion and marketing service), or any other data pertaining to the communication channel between the promotion and marketing service and an entity external to the promotion and marketing service.

As used herein, the term “discretionary data” refers to electronic information provided by a merchant or consumer explicitly to the promotion and marketing service in support of improved interaction with the promotion and marketing service. Upon registering with the promotion and marketing service or at any time thereafter, the consumer or merchant may be invited to provide information that aids the promotion and marketing service in providing services that are targeted to the particular needs of the consumer or merchant. For example, a consumer may indicate interests, hobbies, their age, gender, or location when creating a new account. A merchant may indicate the type of goods or services provided, their retail storefront location, contact information, hours of operation, or the like.

It should be appreciated that the term “discretionary data” is intended to refer to information voluntarily and explicitly provided to the promotion and marketing service, such as by completing a form or survey on a website or application hosted by the promotion and marketing service. However, is should be appreciated that the examples of discretionary data provided above may also be determined implicitly or through review or analysis of other electronic marketing information provided to the promotion and marketing service. It should also be appreciated that the promotion and marketing service may also gate access to certain features or tools based on whether certain discretionary data has been provided. For example, the consumer may be required to provide information relating to their interests or location during a registration process.

As used herein, the term “business analytic data” refers to data generated by the promotion and marketing service based on electronic marketing information to assist with the operation of the promotion and marketing service and/or one or more merchants. The various streams of electronic marketing information provided to and by the promotion and marketing service allow for the use of sophisticated data analysis techniques that may be employed to identify correlations, relationships, and other associations among elements of electronic marketing information. These associations may be processed and formatted by the promotion and marketing service to provide reports, recommendations, and services both internal to the promotion and marketing service and to merchants in order to improve the process by which merchants and promotion and marketing service engage with consumers. For example, the promotion and marketing service may analyze the electronic marketing information to identify an increased demand for a particular product or service, and provide an electronic report to a merchant suggesting the merchant offer the particular product or service. Alternatively, the promotion and marketing service may identify that a particular product or service is not selling well or that sales of the product or service result in the merchant losing money, customers, or market share (e.g., after consumers order a particular menu item, they never come back to the merchant), and suggest that the merchant should discontinue offering that product or service.

It should be appreciated that the term “business analytic data” is intended to refer to electronically and programmatically generated data. For example, a printed report or letter manually drafted by an employee of the promotion and marketing service would not be said to include business analytic data, even if said data was used by the employee during the drafting process, while a data disk or downloaded file containing analytics generated by the promotion and marketing service would be considered business analytic data.

### Overview

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

In some examples, consumers are providing various signals to various products, services, and the like through their various interactions with content provider systems. In some cases, such services may be television, video, and/or music services, where in other examples the services may include shopping, travel, and/or the like. Additionally or alternatively, users may be interacting with various social networks that are standalone networks or are networks that are tied to a particular service, such as the services that were outlined above. In any of the aforementioned examples, the consumer may be sending disparate signals to a number of different services or networks.

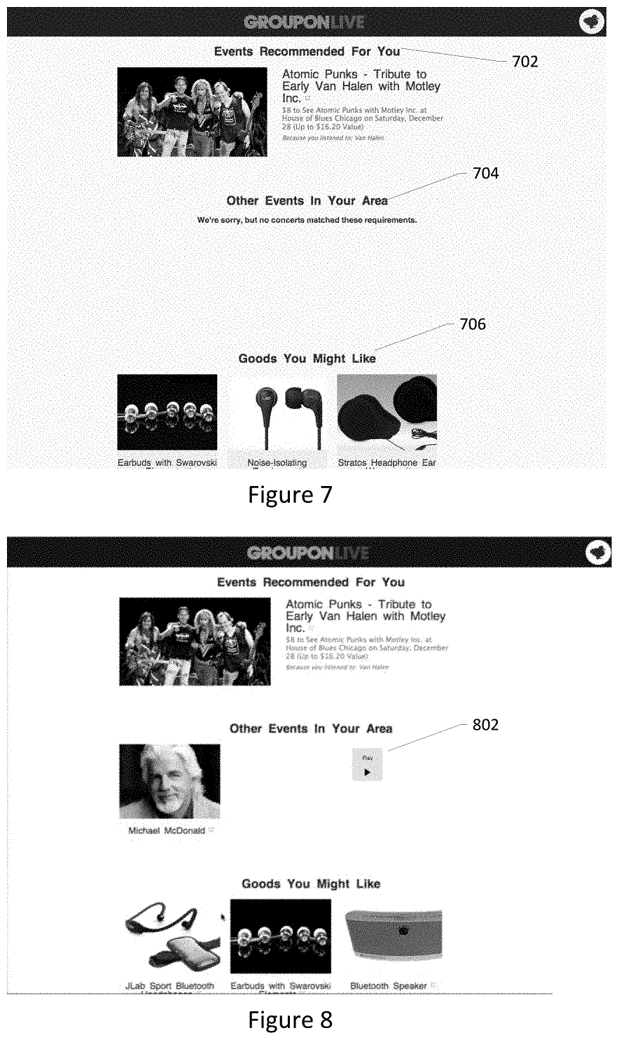

A method, apparatus, and computer program product are provided in accordance with an example embodiment of the present invention for using the aforementioned signals (hereinafter consumer data) in determining relevance signals for promotions to facilitate the generation of impressions for a consumer within a promotion and marketing service application. In some examples, a method, apparatus, and computer program product defined herein may access or otherwise determine one or more preferences, selections, activities, interactions, or the like in an application or service that is separate from the promotion and marketing service for the purpose of determining relevance signals. In one example, the displays of FIGS. 7 and 8 can be used to provide a relatively simple, quick, and intuitive way to provide more relevant promotions to a consumer based on information such as the content that the consumer is currently consuming (for example, a song or video that the consumer is currently playing), the content (for example, music videos, and/or television programs) in a consumer's playlist or library, content recommendations from the consumer's friends or social network, content, such as music or videos, that the consumer's friends are playing, and the like. In some example embodiments, a consumer may use displays, such as displays of FIGS. 7 and 8, to view and/or facilitate the purchase of promotions relevant to the consumer's current activities.

Alternatively or additionally, other applications and services may be accessed, such as social network, shopping, travel, and interest discovery applications and services, and the like, to provide consumer data such as one or more preferences, selections, activities, interactions, or the like for a consumer which may be used in determining relevance signals for promotions that may be provided to the consumer. For example, relevance signals for promotions may be determined based in part on a consumer's interactions with other members of a social network, the members of a consumer's social network, travel arrangements made or shared by a consumer in a travel service, interests, activities, or content that a consumer has tagged or followed in a discovery service, a consumer's purchases, recommendations, or reviews in a shopping service, and the like.

### System Architecture

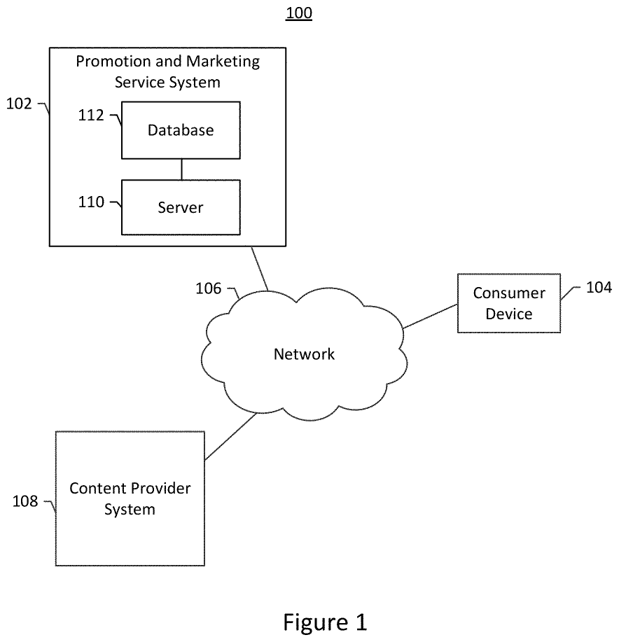

FIG. 1 illustrates a system 100 which provides an example network architecture for a promotion and marketing service, which may include one or more devices and sub-systems that are configured to implement embodiments discussed herein. For example, system 100 may include Promotion and Marketing Service system 102, which may include, for example, promotion analytics and promotion databases, along with other elements. Promotion analytics may include any suitable network server and/or other type of processing device to provide analysis of provider promotions, transaction data, etc. to facilitate the generation and marketing of promotions. Promotional databases may include any suitable network databases configured to store provider and consumer data, promotion data, transaction data, redemption data, and/or the like, such as that discussed herein. In this regard, Promotion and Marketing Service system 102 may include, for example, at least one backend data server, network database, cloud computing device, or the like, among other elements.

For example, the Promotion and Marketing Service system 102 may comprise a server 110 in communication with a database 112. The server 110 may be embodied as a computer or computers as known in the art. The server 110 may provide for receiving of electronic data from various sources, including but not necessarily limited to the consumer devices 104. For example, the server 110 may be operable to receive and process clickstream data provided by the consumer devices 104. The server 110 may also facilitate e-commerce transactions based on transaction information provided by the consumer devices 104. The server 110 may facilitate the generation and providing of various electronic communications and marketing materials based on the received electronic data.

The database 112 may be embodied as a data storage device such as a Network Attached Storage (NAS) device or devices, or as a separate database server or servers. The database 112 includes information accessed and stored by the server 110 to facilitate the operations of the Promotion and Marketing Service system 102. For example, the database 112 may include, without limitation, user account credentials for system administrators, merchants, and consumers, data indicating the products and promotions offered by the promotion and marketing service, clickstream data, analytic results, reports, financial data, and/or the like.

In some embodiments, the Promotion and Marketing Service system 102 may support applications executed on consumer devices 104 that may facilitate providing impressions to the consumer regarding one or more promotions, assist the consumer in searching for available promotions, purchasing promotions, managing purchased promotions, and the like. In some embodiments, the Promotion and Marketing Service system 102 may support providing impressions for promotions based on relevance signals determined from outside consumer data (for example, consumer data contained in a service separate from the Promotion and Marketing Service system 102), such as information associated with audio and/or video files in a consumer's library or playlists, audio and/or video files that a consumer is playing, content recommendations from the consumer's friends or social network, a consumer's interactions with other members of a social network, travel arrangements made or shared by a consumer in a travel service, interests, activities, or content that a consumer has tagged or followed in a discovery service, a consumer's purchases, recommendations, or reviews in a shopping service, and/or the like.

Promotion and Marketing Service system 102 may be coupled to one or more consumer devices 104, such as via network 106. In this regard, network 106 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, network 106 may include a cellular telephone, 802.11, 802.16, 802.20, and/or WiMax network. Further, the network 106 may include a public network, such as the Internet, a private network, such as an intranet, or combinations thereof, and may utilize a variety of networking protocols now available or later developed including, such as, but not limited to, TCP/IP based networking protocols.

Consumer device 104 may be implemented as a personal computer and/or other networked device, such as a cellular phone, tablet computer, laptop computer, mobile device, etc., that may be used for any suitable purpose in addition to searching for and/or viewing promotions, processing transactions, and the like. While FIG. 1 illustrates a single consumer device 104, a plurality of consumer devices may be in communication with the Promotion and Marketing Service system 102. In some embodiments, consumer device 104 may be configured to provide graphical user interfaces, such as illustrated in FIGS. 7 and 8, to facilitate consumer interactions with Marketing and Promotion Service systems, including providing for the display of impressions comprising one or more promotions and purchasing one or more promotions.

Consumer device 104 may also be in communication with a content provider system, such as Content Provider System 108. Content Provider System 108 may facilitate consumers developing libraries and/or playlists of audio and/or video files and provide access to such audio and/or video files, such as music, movies, television programs, video recordings, audio recordings, and/or the like. For example, Content Provider System 108 may provide access to a plurality of music files and allow a consumer to develop playlists such as music by a particular artist or artists, music of a particular genre, custom music selections, and the like. In some embodiments, Content Provider System 108 may also provide social networking features such as allowing consumers to share their current selections, playlists, recommendations, and the like with one or more friends or groups of friends. In some embodiments, Content Provider System 108 may provide a platform for travel, shopping, discovery, and/or social network applications.

### Description of Example Embodiments

In some embodiments, consumer data from sources external to a promotion and marketing service may be used to facilitate relevance determinations for what promotions to present to a consumer in an impression. In some embodiments, one or more consumer preferences, selections, activities, interactions, or the like in a music, video, travel, shopping, discovery, and/or social network application or service may be used in part to determine what promotions may be more relevant to the particular consumer. For example, in some embodiments, information associated with a consumer's library or playlists associated with a content provider, such as a music library service, a video streaming service, or the like, may be used in part to determine what promotions may be more relevant to the particular consumer. In some embodiments, information associated with a consumer's social network within the content provider system may also be used in the determinations of what promotions may be more relevant to the particular consumer.

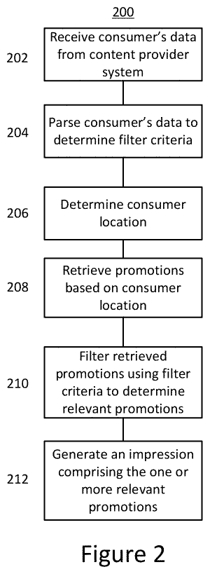

FIG. 2 illustrates a flowchart of exemplary operations for a process 200 that may be executed by one or more apparatuses to facilitate the generation of impressions comprising one or more promotions for a consumer, in accordance with some example embodiments discussed herein. Operations of process 200 may begin at block 202 where a collection of data for a consumer, such as one or more playlists, preferences, selections, activities, interactions, or the like, may be received from a content provider system, such as Content Provider System 108. For example, in some embodiments, operations may be performed by one or more modules, such as an application programming interface, plug-in, or the like, within a content provider application, such as an audio and/or video streaming application, a travel application, a shopping application, a discovery application, a social network application, or the like, and may retrieve collections of consumer data stored by the Content Provider System, such as data stored on one or more servers supporting the Content Provider System. In some example embodiments, such a collection of consumer data may comprise information about a library of audio and/or video files, such as music, movies, television programs, video recordings, audio recordings, and/or the like, for a consumer within the Content Provider System. In some embodiments, such a library may comprise one or more playlists of music or video files arranged by the consumer. In some example embodiments, the consumer data may further comprise information about each of the audio and/or video files within a playlist or library, such as artist name, genre, play/view count, last play/view time, rating, and the like. In some example embodiments, such a collection of consumer data may comprise one or more consumer interactions with other members of a social network, the members of a consumer's social network, travel arrangements made or shared by a consumer in a travel service, interests, activities, or content that a consumer has tagged or followed in a discovery service, a consumer's purchases, recommendations, or reviews in a shopping service, and the like.

At block 204, the received collection of consumer data may be parsed to determine the filter criteria to be used in developing a relevance search of available promotions, for example, using means such as processor 902, memory 904, and/or content relevance determination circuitry 910 of apparatus 900. For example, in some embodiments, the consumer data may be parsed to determine the names of artists within the consumer's library, within a plurality of playlists, or within a single playlist. In some embodiments, the consumer data may also be parsed to determine the relative popularity of an artist compared to other artists within the library or playlist, for instance an overall popularity (e.g., the number of times the music of an artist appears in the library or playlist compared to other artists), the relative popularity of an artist during a time period (e.g., the number of times music of each artist was played in a time period), or the like. In some embodiments, the consumer data may be parsed to determine the genre of the audio and/or video within the consumer's library, within a plurality of playlists, or within a single playlist. In some embodiments, the consumer data may be parsed to determine album titles within the consumer's library, within a plurality of playlists, or within a single playlist. In some embodiments, the consumer data may also be parsed to determine the number of times an artist, genre, etc. appears within the consumer's library, within a plurality of playlists, or within a single playlist.

In some embodiments, the received collection of consumer data may comprise travel information for a consumer, such as travel plans made or shared by the consumer in a travel application and the consumer data may be parsed to determine travel locations and activities for use as filter criteria in developing a relevance search of available promotions. In some embodiments, the received collection of consumer data may comprise interests, topics, projects, activities, and the like that the consumer has tracked or tagged in a discovery application and the consumer data may be parsed to determine subjects or categories for use in developing filter criteria for a relevance search of available promotions. In some embodiments, the received collection of consumer data may comprise a consumer's interactions and/or activities in a social network and the consumer data may be parsed to determine what and/or who the consumer is most actively following, topics or items the consumer has indicated as being liked or indicated as favorites, recommendations made to or by the consumer, and the like for use in developing filter criteria for a relevance search of available promotions.

At block 206, a geographic location may be determined for the consumer and used in developing the relevance search of available promotions, for example, using means such as processor 902, memory 904, communication interfaces 906, input/output interfaces 908, and/or content relevance determination circuitry 910. For example, in some embodiments, the Content Provider System may store an address or location associated with the consumer, such as a billing address or an address or location (for example, the consumer's neighborhood, city, state, region, etc.) in a consumer profile, which may be provided to determine a geographic location of the consumer. In some embodiments, a consumer's device IP address may be captured to determine the geographic location of the consumer. In some embodiments, a consumer device may include a global positioning system (GPS) receiver and the consumer's geographic location may be determined using GPS signals.

At block 208, promotions may be retrieved from a promotion and marketing service, such as from Promotion and Marketing Service system 102, based on the consumer's geographic location, as determined in block 206, for example, using means such as processor 902, memory 904, communication interfaces 906, and/or content relevance determination circuitry 910. For example, in some embodiments, promotions, such as event promotions, may be retrieved from the promotion and marketing service, for example, if they are to occur within a certain distance of the consumer's geographic location (e.g., in the same area, city, region, state, etc.). In some embodiments, promotions, such as shopping, dining, activity promotions, and the like, may be retrieved if they are available within a certain distance of the consumer's geographic location.

At block 210, the retrieved promotions may then be filtered using the filter criteria to determine one or more promotions that may be relevant to the consumer, for example, using means such as processor 902, memory 904, and/or content relevance determination circuitry 910. For example, in some embodiments, the retrieved promotions may be event promotions, such as concerts, performances, or the like, and may be filtered based on one or more artist names, genres, or the like, parsed from the collection of consumer data at block 204. In another example, in some embodiments, the retrieved promotions may be dining, shopping, activity, services, or travel promotions, or the like and may be filtered based on one or more topics, categorizes, subjects, or the like parsed from the collection of consumer data at block 204, such as consumer data from a social network application, shopping application, travel application, interest discovery application, and/or the like. In some embodiments, the filtering may further comprise sorting a plurality of promotions that match the filter criteria, such as by ordering promotions associated with artists in the consumer's library or playlist based on the relative popularity of each artist or genre within the consumer's library or playlist, ordering the promotions based on distance from the consumer's current geographic location, ordering the promotions based on the popularity of topics or categories (for example, the number of appearances of a topic or category, number of likes related to a topic, etc.) within the collection of consumer data, or the like.

At block 212, one or more retrieved and filtered promotions (i.e., promotions matching the relevance search) may be used to generate one or more impressions, for example, using means such as processor 902, memory 904, communication interfaces 906, input/output interfaces 908, and/or content relevance determination circuitry 910, that are to be displayed to the consumer, such as on consumer device 104 and illustrated in the exemplary displays of FIGS. 7 and 8. In some embodiments, an impression may comprise the one or more retrieved and filtered promotions, as well as other promotions within the same geographic area, promotions for goods related to the consumer's current activity (e.g., goods associated with listening to music, watching videos, etc.), and the like.

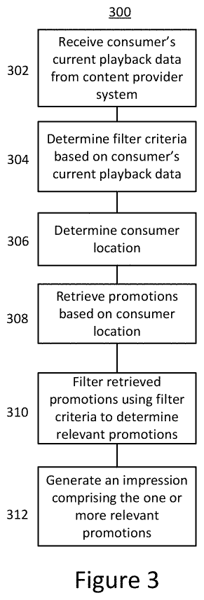

FIG. 3 illustrates a flowchart of exemplary operations for a process 300 that may be executed by one or more apparatuses to facilitate the generation of impressions comprising one or more promotions for a consumer, in accordance with some example embodiments discussed herein. Operations of process 300 may begin at block 302 where a consumer's current playback data may be received from a content provider system, such as Content Provider System 108, for example, using means such as processor 902, memory 904, communication interfaces 906, input/output interfaces 908, and/or content relevance determination circuitry 910 of apparatus 900. For example, in some embodiments, information about the current audio and/or video file (e.g., music, movie, television program, video recording, audio recording, etc.) being played by the consumer may be received. In some embodiments, the current playback data may comprise information about a song or video being played from the consumer's library or playlist in the Content Provider System. In some embodiments, the current playback data may comprise information about an audio and/or video file being played using the Content Provider System that is not within the consumer's library or playlist, for example, new music that the consumer is exploring. In some embodiments, the current playback data may comprise information about the audio and/or video file, such as artist name, genre, and the like.

At block 304, the received collection of current playback data may be parsed to determine the filter criteria to be used in developing a relevance search of available promotions, for example, using means such as processor 902, memory 904, and/or content relevance determination circuitry 910. For example, in some embodiments, the current playback data may be parsed to determine the name of the artist for the current song being played. In some embodiments, the current playback data may be parsed to determine the genre of the audio and/or video being played.

At block 306, a geographic location may be determined for the consumer and used in developing the relevance search of available promotions, for example, using means such as processor 902, memory 904, communication interfaces 906, input/output interfaces 908, and/or content relevance determination circuitry 910. For example, in some embodiments, the Content Provider System may store an address or location associated with the consumer, such as a billing address or an address or location (e.g., city, state, region, etc.) in a consumer profile, which may be provided to determine a geographic location of the consumer. In some embodiments, a consumer's device IP address may be captured to determine the geographic location of the consumer. In some embodiments, a consumer device may include a GPS receiver and the consumer's geographic location may be determined using GPS signals.

At block 308, promotions may be retrieved from a promotion and marketing service, such as from Promotion and Marketing Service system 102, based on the consumer's geographic location, as determined in block 306, for example, using means such as processor 902, memory 904, communication interfaces 906, and/or content relevance determination circuitry 910. For example, in some embodiments, promotions, such as event promotions, may be retrieved if they are to occur within a certain distance of the consumer's geographic location (e.g., in the same area, city, region, state, etc.).

At block 310, the retrieved promotions may be then filtered using the filter criteria to determine one or more promotions that may be relevant to the consumer, for example, using means such as processor 902, memory 904, and/or content relevance determination circuitry 910. For example, in some embodiments, the retrieved promotions may be event promotions, such as concerts, performances, or the like, and may be filtered based on the artist name or genre parsed from the current playback data. In some embodiments, the filtering may further comprise sorting a plurality of promotions that match the filter criteria, such as by ordering the promotions based on distance from the consumer's current geographic location, or the like.

At block 312, one or more retrieved and filtered promotions (i.e., promotions matching the relevance search) may be used to generate one or more impressions, for example, using means such as processor 902, memory 904, communication interfaces 906, input/output interfaces 908, and/or content relevance determination circuitry 910, that are to be displayed to the consumer, such as on consumer device 104 and illustrated in the exemplary displays of FIGS. 7 and 8. In some embodiments, an impression may comprise the one or more retrieved and filtered promotions, as well as other promotions within the same geographic area, promotions for goods related to the consumer's current activity (e.g., goods associated with listening to music, watching videos, etc.), and the like.

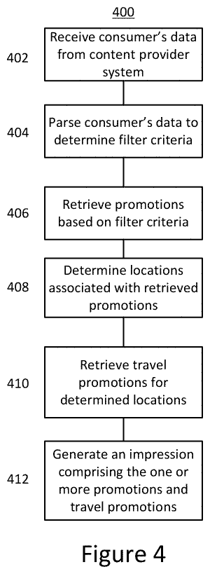

FIG. 4 illustrates a flowchart of exemplary operations for a process 400 that may be executed by one or more apparatuses to facilitate the generation of impressions comprising one or more promotions for a consumer, in accordance with some example embodiments discussed herein. Operations of process 400 may begin at block 402 where a collection of data for a consumer may be received from a content provider system, such as Content Provider System 108, for example, using means such as processor 902, memory 904, communication interfaces 906, input/output interfaces 908, and/or content relevance determination circuitry 910. In some example embodiments, such a collection of consumer data may comprise information about a library of audio and/or video files, such as music, movies, television programs, video recordings, audio recordings, and/or the like, compiled by a consumer using the Content Provider System. In some embodiments, such a library may comprise one or more playlists of music or video files arranged by the consumer. In some example embodiments, the consumer data may further comprise information about each of the audio and/or video files within a playlist or library, such as artist name, genre, play/view count, last play/view time, ranking, and the like.

At block 404, the received collection of consumer data may be parsed to determine the filter criteria to be used in developing a relevance search of available promotions, for example, using means such as processor 902, memory 904, and/or content relevance determination circuitry 910. For example, in some embodiments, the consumer data may be parsed to determine the names of artists within the consumer's library, within a plurality of playlists, or within a single playlist. In some embodiments, the consumer data may also be parsed to determine the relative popularity of an artist or genre compared to other artists or genres within the library or playlist, for instance an overall popularity (e.g., the number of times the music of an artist or genre appears in the library or playlist compared to other artists or genres), the relative popularity of an artist during a time period (e.g., the number of times music of each artist was played in a time period), or the like. In some embodiments, the consumer data may be parsed to determine the genre of the audio and/or video within the consumer's library, within a plurality of playlists, or within a single playlist. In some embodiments, the consumer data may be parsed to determine album titles within the consumer's library, within a plurality of playlists, or within a single playlist. In some embodiments, the consumer data may also be parsed to determine the number of times an artist, genre, etc. appears within the consumer's library, within a plurality of playlists, or within a single playlist.

At block 406, promotions may be retrieved from a promotion and marketing service, such as from Promotion and Marketing Service system 102, for example, using means such as processor 902, memory 904, communication interfaces 906, and/or content relevance determination circuitry 910. The retrieved promotions may be then filtered using the filter criteria to determine one or more promotions that may be relevant to the consumer. For example, in some embodiments, the retrieved promotions may be event promotions, such as concerts, performances, or the like, and may be filtered based on one or more artist names parsed from the collection of consumer data. In some embodiments, the filtering may further comprise sorting a plurality of promotions that match the filter criteria, such as by ordering promotions associated with artists in the consumer's library or playlist based on the relative popularity of each artist within the consumer's library or playlist, ordering the promotions based on distance from the consumer's current geographic location, or the like.

At block 408, locations associated with each of the retrieved and filtered promotions may be determined, for example, using means such as processor 902, memory 904, communication interfaces 906, and/or content relevance determination circuitry 910. For example, in some embodiments, for promotions such as event promotions, the geographic location where the event is to occur may be determined (e.g., the area, city, region, state, etc. where the event is to be held).

At block 410, the locations determined for the retrieved and filtered promotions may be used to retrieve one or more travel promotions (e.g., promotions for one or more of transportation, lodging, dining, etc.) associated with the determined locations, for example, using means such as processor 902, memory 904, communication interfaces 906, input/output interfaces 908, and/or content relevance determination circuitry 910.

At block 412, one or more retrieved and filtered promotions and one or more travel promotions associated with the locations for the retrieved and filtered promotions may be used to generate one or more impressions that may be presented to the consumer, such as on consumer device 104, for example, using means such as processor 902, memory 904, communication interfaces 906, input/output interfaces 908, and/or content relevance determination circuitry 910.

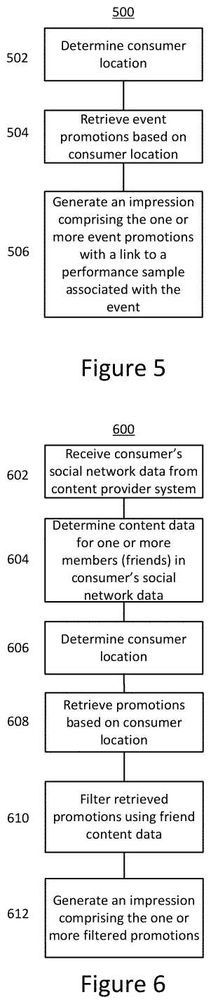

FIG. 5 illustrates a flowchart of exemplary operations for a process 500 that may be executed by one or more apparatuses to facilitate the generation of impressions comprising one or more promotions for a consumer, in accordance with some example embodiments discussed herein. In some embodiments, as illustrated in the operations of FIG. 5, a promotion and marketing service system may provide for assisting a consumer in discovering new artists, genres, etc. by generating impressions for promotions associated with such artists, genres, etc. which also provide the ability to access performance samples related to the event promotion. In this way, a promotion and marketing service system may encourage discovery and/or purchase of event promotions for artists with which a consumer is unfamiliar. For example, in some embodiments, a promotion and marketing service system may generate impressions for upcoming event promotions that also provide links to samples of music for an artist associated with the event promotion.

Operations of process 500 may begin at block 502 where a geographic location may be determined for the consumer and used in developing the relevance search of available promotions, for example, using means such as processor 902, memory 904, communication interfaces 906, input/output interfaces 908, and/or content relevance determination circuitry 910. For example, in some embodiments, the Content Provider System may store an address or location associated with the consumer, such as a billing address or an address or location (e.g., city, state, region, etc.) in a consumer profile, which may be provided to determine a geographic location of the consumer. In some embodiments, a consumer's device IP address may be captured to determine the geographic location of the consumer. In some embodiments, a consumer device may include a GPS receiver and the consumer's geographic location may be determined using GPS signals.

At block 504, promotions may be retrieved from a promotion and marketing service, such as from Promotion and Marketing Service system 102, based on the consumer's geographic location, for example, using means such as processor 902, memory 904, communication interfaces 906, input/output interfaces 908, and/or content relevance determination circuitry 910. For example, in some embodiments, promotions, such as event promotions, may be retrieved if they are to occur within a certain distance of the consumer's geographic location (e.g., in the same area, city, region, state, etc.).

At block 506, one or more retrieved promotions (i.e., event promotions) may be used to generate one or more impressions, for example, using means such as processor 902, memory 904, communication interfaces 906, input/output interfaces 908, and/or content relevance determination circuitry 910. that are to be displayed to the consumer, such as on consumer device 104, where the one or more impressions further comprise links to one or more performance samples associated with each of the one or more event promotions (e.g., links to one or more music samples for an artist performing at the event).

FIG. 6 illustrates a flowchart of exemplary operations for a process 600 that may be executed by one or more apparatuses to facilitate the generation of impressions comprising one or more promotions for a consumer, in accordance with some example embodiments discussed herein. In some embodiments, as illustrated in the operations of FIG. 6, a promotion and marketing service system may facilitate using social aspects of a content provider system in developing relevance determinations for what promotions to include for a consumer in one or more impressions. For example, in some embodiments, a promotion and marketing service system may analyze actions associated with members of a consumer's social network (i.e., friends) in the content provider system to for use in making relevance determinations for promotions. For example, the promotion and marketing service system may generate impressions that indicate one or more of the consumer's friends might also be interested in a particular promotion because they also like the artist, performer, topic, activity, or the like and encourage the consumer to share the impression. In another example, the promotion and marketing service system may generate impressions that indicate that one of the consumer's friends purchased a promotion associated with an artist, performer, topic, activity, or the like that the consumer also likes, suggesting that the consumer might also want to purchase that promotion. In another example, the promotion and marketing service system may generate impressions that indicate that one of the consumer's friends is listening to a particular artist and a promotion associated with that artist is available or that one of the consumer's friends has tracked or tagged a particular topic, interest, activity, or the like as a favorite item and a promotion associated with that particular topic, interest, or activity is available (e.g., facilitating the gifting of promotions). In another example, the promotion and marketing service system may generate impressions based on recommendations, reviews, activities, or the like of one of the consumer's friends who the consumer actively follows.

Operations of process 600 may begin at block 602 where a collection of social network data for a consumer may be received from a content provider system, such as Content Provider System 108, for example, using means such as processor 902, memory 904, communication interfaces 906, and/or content relevance determination circuitry 910. In some example embodiments, such a collection of consumer social network data may comprise information about the members of the consumer's social network (i.e., friends), about recommendations provided by the consumer's friends, about the activities or interactions of the consumer's friends, about the content being played by the consumer's friends, about the consumer's interactions with their friends, about promotions purchased by the consumer's friends, and the like.

At block 604, the received collection of consumer social network data may be parsed to determine the filter criteria to be used in developing a relevance search of available promotions, for example, using means such as processor 902, memory 904, and/or content relevance determination circuitry 910. For example, in some embodiments, the consumer data may be parsed to determine which friends the consumer interacts with the most, which friends are influencers in the consumer's social network, whose recommendations or activities the consumer follows, people, topics, items, and the like that the consumer has indicated as liked or favorites, and the like, which may then be used in developing the filter criteria.

At block 606, a geographic location may be determined for the consumer and be used in developing the relevance search of available promotions, for example, using means such as processor 902, memory 904, communication interfaces 906, input/output interfaces 908, and/or content relevance determination circuitry 910. For example, in some embodiments, the Content Provider System may store an address or location associated with the consumer, such as a billing address or an address or location (e.g., city, state, region, etc.) in a consumer profile, which may be provided to determine a geographic location of the consumer. In some embodiments, a consumer's device IP address may be captured to determine the geographic location of the consumer. In some embodiments, a consumer device may include a GPS receiver and the consumer's geographic location may be determined using GPS signals.

At block 608, promotions may be retrieved from a promotion and marketing service, such as from Promotion and Marketing Service system 102, based on the consumer's geographic location, for example, using means such as processor 902, memory 904, communication interfaces 906, and/or content relevance determination circuitry 910. For example, in some embodiments, promotions, such as event promotions, may be retrieved if they are to occur within a certain distance of the consumer's geographic location (e.g., in the same area, city, region, state, etc.). In some embodiments, promotions, such as promotions for shopping, dining, activities, and the like, may be retrieved if they are available within a certain distance of the consumer's geographic location.

At block 610, the retrieved promotions may be then filtered using the filter criteria to determine one or more promotions that may be relevant to the consumer, for example, using means such as processor 902, memory 904, and/or content relevance determination circuitry 910. For example, in some embodiments, the retrieved promotions may be event promotions, such as concerts, performances, and the like, activity promotions, dining promotions, shopping promotions, travel or vacation promotions, and the like, and may be filtered based in part on relevance determinations associated with which of the consumer's friends are influencers, what interactions those influencer friends have with the consumer, what selections those influencer friends have made, and the like.

At block 612, one or more retrieved and filtered promotions (i.e., promotions matching the relevance search) may be used to generate one or more impressions, for example, using means such as processor 902, memory 904, communication interfaces 906, input/output interfaces 908, and/or content relevance determination circuitry 910, that are to be displayed to the consumer, such as on consumer device 104. In some embodiments, an impression may comprise the one or more retrieved and filtered promotions, as well as other promotions within the same geographic area, promotions for goods related to the consumer's current activity (e.g., goods associated with listening to music, watching videos, etc.), and the like.

FIGS. 7 and 8 illustrate some example graphical user interface displays that may be presented by various components of systems or devices in accordance with some example embodiments discussed herein.

FIG. 7 illustrates an exemplary display screen presenting an impression with one or more promotions returned in accordance with some example embodiments discussed herein. Section 702 of FIG. 7 provides for the display of one or more promotions that were selected based on relevance determinations as discussed herein, for example events within the consumer's area that match an artist in the consumer's library. Section 704 of FIG. 7 may provide for the display of one or more other promotions that are also in the consumer's area but may not match a popular artist in the consumer's library. In FIG. 7, section 704 indicates that no matching event promotions were found. Section 706 of FIG. 7 provides for the display of one or more other types of promotions that may be related to the consumer's current activity, such as goods promotions associated with the consumer's activity (e.g., promotions for headphones when listening to music).

FIG. 8 illustrates another exemplary display screen presenting an impression with one or more promotions returned in accordance with some example embodiments discussed herein and illustrates features similar to those discussed above with regard to FIG. 7. Section 802 of FIG. 8 illustrates the display of one or more other promotions that are also in the consumer's area but may not match a popular artist in the consumer's library. In some embodiments, the impression may include links to allow the consumer to access a performance sample for the artists associated with an event, such as links to sample music tracks for an artist.

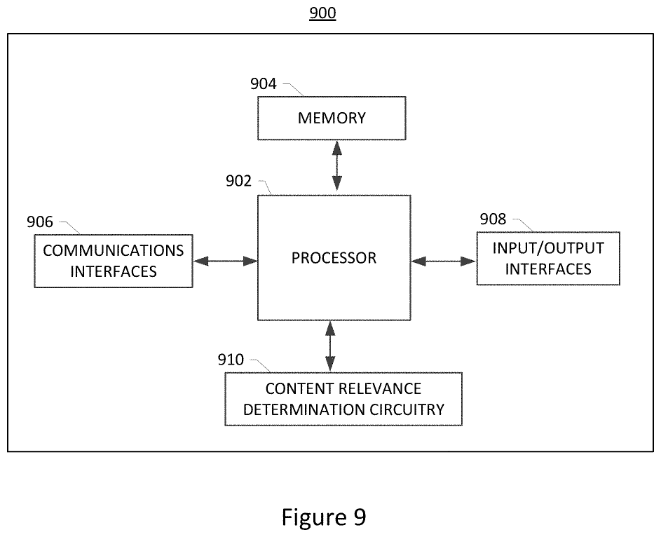

FIG. 9 shows a block diagram of apparatus 900, some or all of which may be included in, for example, a promotion and marketing service system 102, and/or consumer device 104. As illustrated in FIG. 9, in accordance with some example embodiments, apparatus 900 can include various means, such as one or more processors 902, memories 904, communications interfaces 906, input/output interfaces 908, and/or content relevance determination circuitry 910. In this regard, the means of apparatus 900 as described herein may be embodied as, for example, circuitry, hardware elements (e.g., a suitably programmed processor, combinational logic circuit, and/or the like), a computer program product comprising computer-readable program instructions stored on a non-transitory computer-readable medium that is executable by a suitably configured processing device (e.g., processor 902), or some combination thereof.

The apparatus 900 may be configured to execute the operations described above with respect to FIGS. 1 through 8. Although these components are described with respect to functional limitations, it should be understood that the particular implementations necessarily include the use of particular hardware. It should also be understood that certain of these components may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the apparatus 900 may provide or supplement the functionality of particular circuitry. For example, the processor 902 may provide processing functionality, the memory 904 may provide storage functionality, the communications circuitry 906 may provide network interface functionality, and the like.

Processor 902 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 9 as a single processor, in some embodiments, processor 902 comprises a plurality of processors. The plurality of processors may be embodied on a single computing device or may be distributed across a plurality of computing devices collectively configured to function as apparatus 900. The plurality of processors may be in operative communication with each other and may be collectively configured to perform one or more functionalities of apparatus 900 as described herein. In an example embodiment, processor 902 is configured to execute instructions stored in memory 904 or otherwise accessible to processor 902, such as instructions stored on a non-transitory computer-readable medium. These instructions, when executed by processor 902, may cause apparatus 900 to perform one or more of the functionalities of the embodiments as described herein.

Whether configured by hardware, firmware/software methods, or by a combination thereof, processor 902 may comprise an entity (e.g., physically embodied in circuitry) capable of performing operations according to embodiments of the present invention while configured accordingly. Thus, for example, when processor 902 is embodied as an ASIC, FPGA, or the like, processor 902 may comprise specifically configured hardware for conducting one or more operations described herein. As another example, when processor 902 is embodied as an executor of instructions, such as may be stored in memory 904, the instructions may specifically configure processor 902 to perform one or more algorithms and operations described herein, such as those discussed in connection with FIGS. 2-6.

Memory 904 may comprise, for example, volatile memory, non-volatile memory, or some combination thereof. Although illustrated in FIG. 9 as a single memory, memory 904 may comprise a plurality of memory components. The plurality of memory components may be embodied on a single computing device or distributed across a plurality of computing devices. In various embodiments, memory 904 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 904 may be configured to store information, data, applications, instructions, or the like for enabling apparatus 900 to carry out various functions in accordance with example embodiments of the present invention. For example, in at least some embodiments, memory 904 is configured to buffer input data for processing by processor 902. Additionally or alternatively, in at least some embodiments, memory 904 is configured to store program instructions for execution by processor 902. Memory 904 may store information in the form of static and/or dynamic information. This stored information may be stored and/or used by apparatus 900 during the course of performing its functionalities.

Communications interface 906 may be embodied as any device or means embodied in circuitry, hardware, a computer program product comprising computer readable program instructions stored on a computer readable medium (e.g., memory 904) and executed by a processing device (e.g., processor 902), or a combination thereof that is configured to receive and/or transmit data from/to another device, such as, for example, a second apparatus 900 and/or the like. In some embodiments, communications interface 906 (like other components discussed herein) can be at least partially embodied as or otherwise controlled by processor 902. In this regard, communications interface 906 may be in communication with processor 902, such as via a bus. Communications interface 906 may include, for example, an antenna, a transmitter, a receiver, a transceiver, network interface card and/or supporting hardware and/or firmware/software for enabling communications with another computing device. Communications interface 906 may be configured to receive and/or transmit any data that may be stored by memory 904 using any protocol that may be used for communications between computing devices. Communications interface 906 may additionally or alternatively be in communication with the memory 904, input/output interfaces 908 and/or any other component of apparatus 900, such as via a bus.

Input/output interfaces 908 may be in communication with processor 902 to receive an indication of a user input and/or to provide an audible, visual, mechanical, or other output to a user (e.g., a consumer). Some example visual outputs that may be provided to a user by apparatus 900 are discussed in connection with FIGS. 7 and 8. As such, input/output interfaces 908 may include support, for example, for a keyboard, a mouse, a joystick, a display, a touch screen display, a microphone, a speaker, a RFID reader, barcode reader, biometric scanner, and/or other input/output mechanisms. In embodiments wherein apparatus 900 is embodied as a server or database, aspects of input/output interfaces 908 may be reduced as compared to embodiments where apparatus 900 is implemented as an end-user machine (e.g., a consumer device) or other type of device designed for complex user interactions. In some embodiments (like other components discussed herein), input/output interfaces 908 may even be eliminated from apparatus 900. Input/output interfaces 908 may be in communication with the memory 904, communications interface 906, and/or any other component(s), such as via a bus. Although more than one input/output interface and/or other component can be included in apparatus 900, only one is shown in FIG. 9 to avoid overcomplicating the drawing (like the other components discussed herein).

Content relevance determination circuitry 910 includes hardware configured to identify and determine promotions to be offered to consumers based on operations described above in regard to FIGS. 2 through 6, for example by receiving, parsing, filtering, and/or analyzing consumer data received from a content provider system and/or other consumer data and generating impressions based on such parsing, filtering, and/or analyzing. The content relevance determination circuitry 910 may utilize processing circuitry, such as the processor 202, to perform these actions. The content relevance determination circuitry 910 may receive the consumer data via one or more modules, such as an application programming interface, plug-in, or the like and may retrieve collections of consumer data stored by the Content Provider System such as via a network interface provided by the communications circuitry 208. However, it should also be appreciated that, in some embodiments, the content relevance determination circuitry 910 may include a separate processor, specially configured field programmable gate array (FPGA), or application specific interface circuit (ASIC) to perform the receiving, parsing, and filtering of consumer data as well as the generation of impressions. The content relevance determination circuitry 910 may therefore be implemented using hardware components of the apparatus configured by either hardware or software for implementing these planned functions.

In some embodiments, some or all of the functionality for facilitating consumer interactions with Marketing and Promotion Service systems such as facilitating relevance determinations and the generation of impressions for a consumer may be performed by processor 902. In this regard, the example processes and algorithms discussed herein can be performed by at least one processor 902. For example, non-transitory computer readable storage media can be configured to store firmware, one or more application programs, and/or other software, which include instructions and other computer-readable program code portions that can be executed to control each processor (e.g., processor 902) of the components of system 100 to implement various operations, including the examples shown above. As such, a series of computer-readable program code portions are embodied in one or more computer program products and can be used, with a computing device, server, and/or other programmable apparatus, to produce machine-implemented processes.

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

It is also noted that all or some of the information presented by the example displays discussed herein can be based on data that is received, generated and/or maintained by one or more components of system 100. In some embodiments, one or more external systems (such as a remote cloud computing and/or data storage system) may also be leveraged to provide at least some of the functionality discussed herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Embodiments of the present invention have been described above with reference to block diagrams and flowchart illustrations of methods, apparatuses, systems, and computer program products. It will be understood that each block of the circuit diagrams and process flowcharts, and combinations of blocks in the circuit diagrams and process flowcharts, respectively, can be implemented by various means including computer program instructions. These computer program instructions may be loaded onto a general purpose computer, special purpose computer, or other programmable data processing apparatus, such as processor 902 discussed above with reference to FIG. 9, to produce a machine, such that the computer program product includes the instructions which execute on the computer or other programmable data processing apparatus create a means for implementing the functions specified in the flowchart block or blocks.

These computer program instructions may also be stored in a computer-readable storage medium (e.g., memory 904) that can direct a computer or other programmable data processing apparatus to function in a particular manner, such that the instructions stored in the computer-readable storage medium produce an article of manufacture including computer-readable instructions for implementing the function discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein. Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims.

Some additional example embodiments of the present invention are provided as follows.

An example method for generating promotion impressions comprises receiving consumer data from a content provider system, wherein the consumer data comprises one or more indications of consumer preferences for interacting with the content provider system; determining one or more available promotions based in part on the consumer data, the one or more available promotions having redemption parameters that satisfy one or more of indications in the consumer data; and generating an impression within the content provider system comprising the one or more available promotions.

In some embodiments, the method may further include determining a location for the consumer and filtering the one or more available promotions based on the consumer location. In some embodiments, the method may further include wherein the one or more available promotions comprise performance event promotions.

In some embodiments, the method may further include wherein the consumer data comprises artist information stored in a library associated with the consumer in the content provider system. In some embodiments, the method may further include wherein the one or more available promotions are presented in an order based on a play frequency for an artist or a frequency of appearance of an artist in the consumer data.

In some embodiments, the method may further include wherein the consumer data comprises artist information stored in a playlist associated with the consumer in the content provider system. In some embodiments, the method may further include wherein the consumer data comprises artist information for a file currently being played by the consumer in the content provider system.

In some embodiments, the method may further include wherein the consumer data comprises genre information stored in a library associated with the consumer in the content provider system. In some embodiments, the method may further include wherein the consumer data comprises movie information stored in a library associated with the consumer in the content provider system.

In some embodiments, the method may further include wherein the consumer data comprises interactions of the consumer with members of a social network in the content provider system. In some embodiments, the method may further include wherein the consumer's interactions comprise one or more of artists being played by one or more members of the consumer's social network; artists recommended to the consumer by one or more members of the consumer's social network; or promotions purchased by one or more members of the consumer's social network.

Another example method for generating promotion impressions comprises receiving consumer data from a content provider system; determining one or more available event promotions based in part on the consumer data; determining one or more travel promotions associated with the location of the one or more available event promotions; and generating an impression within the content provider system comprising the one or more available event promotions and the one or more travel promotions.

An example apparatus comprises at least one processor and at least one memory including computer-executable program instructions, the computer-executable program instructions configured to, with the at least one processor, cause the apparatus to at least receive consumer data from a content provider system, wherein the consumer data comprises one or more indications of consumer preferences for interacting with the content provider system; determine one or more available promotions based in part on the consumer data, the one or more available promotions having redemption parameters that satisfy one or more of indications in the consumer data; and generate an impression within the content provider system comprising the one or more available promotions.

In some embodiments, the apparatus may further comprise computer-executable program instructions configured to, with the at least one processor, cause the apparatus to determine a location for the consumer and filter the one or more available promotions based on the consumer location. In some embodiments, the apparatus may further comprise wherein the one or more available promotions comprise performance event promotions.

In some embodiments, the apparatus may further comprise wherein the consumer data comprises artist information stored in a library associated with the consumer in the content provider system. In some embodiments, the apparatus may further comprise wherein the one or more available promotions are presented in an order based on a play frequency for an artist or a frequency of appearance of an artist in the consumer data.

In some embodiments, the apparatus may further comprise wherein the consumer data comprises artist information stored in a playlist associated with the consumer in the content provider system. In some embodiments, the apparatus may further comprise wherein the consumer data comprises artist information for a file currently being played by the consumer in the content provider system.

In some embodiments, the apparatus may further comprise wherein the consumer data comprises genre information stored in a library associated with the consumer in the content provider system. In some embodiments, the apparatus may further comprise wherein the consumer data comprises movie information stored in a library associated with the consumer in the content provider system.

In some embodiments, the apparatus may further comprise wherein the consumer data comprises interactions of the consumer with members of a social network in the content provider system. In some embodiments, the apparatus may further comprise wherein the consumer's interactions comprise one or more of: artists being played by one or more members of the consumer's social network; artists recommended to the consumer by one or more members of the consumer's social network; or promotions purchased by one or more members of the consumer's social network.

Another example apparatus comprises at least one processor and at least one memory including computer-executable program instructions, the computer-executable program instructions configured to, with the at least one processor, cause the apparatus to at least receive consumer data from a content provider system; determine one or more available event promotions based in part on the consumer data; determine one or more travel promotions associated with the location of the one or more available event promotions; and generate an impression within the content provider system comprising the one or more available event promotions and the one or more travel promotions.

An example computer program product comprises at least one non-transitory computer-readable storage medium having computer-executable program instructions stored therein, the computer-executable program instructions comprising program instructions, when executed by a processor, configured to receive consumer data from a content provider system, wherein the consumer data comprises one or more indications of consumer preferences for interacting with the content provider system; determine one or more available promotions based in part on the consumer data, the one or more available promotions having redemption parameters that satisfy one or more of indications in the consumer data; and generate an impression within the content provider system comprising the one or more available promotions.

In some embodiments, the computer program product may further comprise program instructions, when executed by a processor, configured to determine a location for the consumer and filter the one or more available promotions based on the consumer location. In some embodiments, the computer program product may further comprise wherein the one or more available promotions comprise performance event promotions.

In some embodiments, the computer program product may further comprise wherein the consumer data comprises artist information stored in a library associated with the consumer in the content provider system. In some embodiments, the computer program product may further comprise wherein the one or more available promotions are presented in an order based on a play frequency for an artist or a frequency of appearance of an artist in the consumer data.

In some embodiments, the computer program product may further comprise wherein the consumer data comprises artist information stored in a playlist associated with the consumer in the content provider system. In some embodiments, the computer program product may further comprise wherein the consumer data comprises artist information for a file currently being played by the consumer in the content provider system.

In some embodiments, the computer program product may further comprise wherein the consumer data comprises genre information stored in a library associated with the consumer in the content provider system. In some embodiments, the computer program product may further comprise wherein the consumer data comprises movie information stored in a library associated with the consumer in the content provider system.

In some embodiments, the computer program product may further comprise wherein the consumer data comprises interactions of the consumer with members of a social network in the content provider system. In some embodiments, the computer program product may further comprise wherein the consumer's interactions comprise one or more of: artists being played by one or more members of the consumer's social network; artists recommended to the consumer by one or more members of the consumer's social network; or promotions purchased by one or more members of the consumer's social network.

Another example computer program product comprises at least one non-transitory computer-readable storage medium having computer-executable program instructions stored therein, the computer-executable program instructions comprising program instructions, when executed by a processor, configured to receive consumer data from a content provider system; determine one or more available event promotions based in part on the consumer data; determine one or more travel promotions associated with the location of the one or more available event promotions; and generate an impression within the content provider system comprising the one or more available event promotions and the one or more travel promotions.

1-36. (canceled)

37. An apparatus for generating an interactive user interface, the apparatus comprising at least one processor and at least one memory including computer-executable program instructions, the computer-executable program instructions configured to, with the at least one processor, cause the apparatus to at least:
retrieve consumer data from the content provider system via a network, wherein the consumer data is generated by at least one application executing on the consumer device;
determine a geographic location of a user of the consumer device based at least in part on GPS signals generated by the consumer device;
determine a first filter criteria based at least in part on the determined geographic location;
retrieve, from a promotion and marketing system database and based at least in part on the first filter criteria, a plurality of available promotions occurring within a certain distance of the geographic location;
receive discretionary data associated with the user via a user interface of the consumer device;
determine, based at least in part on the discretionary data, a subset of filtered promotions from the plurality of available promotions that are determined to be relevant to the user; and
output at least one of the subset of filtered promotions within the interactive user interface of the consumer device.

38. The apparatus of claim 37, wherein the computer-executable program instructions are further configured to, with the at least one processor, cause the apparatus to at least:
identify, based at least in part on analysis of the consumer data, at least another user of the at least one application executing on the consumer device;
determine, a second filter criteria based at least on consumer interaction data associated with the at least another user; and
determine, at least one of the subset of filtered promotions based at least in part on the second filter criteria.

39. The apparatus of claim 38, wherein the consumer interaction data comprises one or more of purchase information and recommendation information generated by the at least another user via a second user interface of another consumer device.

40. The apparatus of claim 38, wherein the consumer data comprises audio and video data generated by a first application executing on the consumer device and social network data generated by a second application executing on the consumer device.

41. The apparatus of claim 38, wherein the consumer interaction data comprises at least one of audio data, video data, clickstream data, and activity data associated with the at least another user.

42. The apparatus of claim 37, wherein the computer-executable program instructions are further configured to, with the at least one processor, cause the apparatus to at least:
identify, based at least in part on the consumer data, an increased demand for a particular product or service; and
generate a data file comprising analytic data associated with at least one product or service corresponding with the subset of filtered promotions.

43. The apparatus of claim 37, wherein the interactive user interface is further configured to facilitate purchase of at least one of the subset of filtered promotions.

44. A computer-implemented method for generating an interactive user interface by at least one server comprising relevance determination circuitry, the at least one server in electronic communication with a consumer device and a content provider system via a network, the computer-implemented method comprising:
retrieving, by the relevance determination circuitry, consumer data from the content provider system via the network, wherein the consumer data is generated by at least one application executing on the consumer device;
determining, by the relevance determination circuitry, a geographic location of a user of the consumer device based at least in part on Global Positioning System (GPS) signals generated by the consumer device;
determining, by the relevance determination circuitry, a first filter criteria based at least in part on the determined geographic location;
retrieving from a promotion and marketing system database, by the relevance determination circuitry and based at least in part on the first filter criteria, a plurality of available promotions occurring within a certain distance of the geographic location;
receiving, by the relevance determination circuitry, discretionary data associated with the user via a user interface of the consumer device;
determining, by the relevance determination circuitry and based at least in part on the discretionary data, a subset of filtered promotions from the plurality of available promotions that are determined to be relevant to the user; and
outputting, by the relevance determination circuitry, at least one of the subset of filtered promotions within the interactive user interface of the consumer device.

45. The computer-implemented method of claim 44, the computer-implemented method further comprising:
identifying, by the relevance determination circuitry and based at least in part on analysis of the consumer data, at least another user of at the at least one application executing on the consumer device;
determining, by the relevance determination circuitry, a second filter criteria based at least on consumer interaction data associated with the at least another user; and
determining, by the relevance determination circuitry, at least one of the subset of filtered promotions based at least in part on the second filter criteria.

46. The computer-implemented method of claim 45, wherein the consumer interaction data comprises one or more of purchase information and recommendation information generated by the at least another user via a second user interface of another consumer device.

47. The computer-implemented method of claim 45, wherein the consumer data comprises audio and video data generated by a first application executing on the consumer device and social network data generated by a second application executing on the consumer device.

48. The computer-implemented method of claim 45, wherein the consumer interaction data comprises at least one of audio data, video data, clickstream data, and activity data associated with the at least another user.

49. The computer-implemented method of claim 44, further comprising:
identifying, by the promotion and marketing system, based at least in part on the consumer data, an increased demand for a particular product or service; and
generating, by the promotion and marketing system, a data file comprising analytic data associated with at least one product or service corresponding with the subset of filtered promotions.

50. The computer-implemented method of claim 44, wherein the interactive user interface is further configured to facilitate purchase of at least one of the subset of filtered promotions.

51. A computer program product for generating an interactive user interface, the computer program product comprising at least one non-transitory computer-readable storage medium storing computer-executable program instructions which, when executed by a processor, configure the processor to:
retrieve consumer data from the content provider system via a network, wherein the consumer data is generated by at least one application executing on the consumer device;
determine a geographic location of a user of the consumer device based at least in part on GPS signals generated by the consumer device;
determine a first filter criteria based at least in part on the determined geographic location;
retrieve, from a promotion and marketing system database and based at least in part on the first filter criteria, a plurality of available promotions occurring within a certain distance of the geographic location;
receive discretionary data associated with the user via a user interface of the consumer device;
determine, based at least in part on the discretionary data, a subset of filtered promotions from the plurality of available promotions that are determined to be relevant to the user; and
output at least one of the subset of filtered promotions within the interactive user interface of the consumer device.

52. The computer program product of claim 51, wherein the computer-executable program instructions are further configured to, with the at least one processor, cause the apparatus to at least:
identify, based at least in part on analysis of the consumer data, at least another user of the at least one application executing on the consumer device;
determine, a second filter criteria based at least on consumer interaction data associated with the at least another user; and
determine, at least one of the subset of filtered promotions based at least in part on the second filter criteria.

53. The computer program product of claim 52, wherein the consumer interaction data comprises one or more of purchase information and recommendation information generated by the at least another user via a second user interface of another consumer device.

54. The computer program product of claim 52, wherein the consumer data comprises audio and video data generated by a first application executing on the consumer device and social network data generated by a second application executing on the consumer device.

55. The computer program product of claim 52, wherein the consumer interaction data comprises at least one of audio data, video data, clickstream data, and activity data associated with the at least another user.

56. The computer program product of claim 51, wherein the computer-executable program instructions are further configured to, with the at least one processor, cause the apparatus to at least:
identify, based at least in part on the consumer data, an increased demand for a particular product or service; and
generate a data file comprising analytic data associated with at least one product or service corresponding with the subset of filtered promotions.
